(19) United States
(12) Patent Application Publication
(10) Pub. No.: US 2018/0260994 A1
(43) Pub. Date: Sep. 13, 2018

(54) EXPRESSION ANIMATION GENERATION METHOD AND APPARATUS FOR HUMAN FACE MODEL

(71) Applicant: TENCENT TECHNOLOGY (SHENZHEN) COMPANY LIMITED, Shenzhen (CN)

(72) Inventors: Lan LI, Guangdong (CN); Qiang WANG, Guangdong (CN); Chen CHEN, Guangdong (CN); Xiao Meng LI, Guangdong (CN); Fan YANG, Guangdong (CN); Yu Cheng QU, Guangdong (CN)

(73) Assignee: TENCENT TECHNOLOGY (SHENZHEN) COMPANY LIMITED, Shenzhen (CN)

(21) Appl. No.: 15/978,281

(22) Filed: May 14, 2018

Related U.S. Application Data
(63) Continuation of application No. PCT/CN2016/108591, filed on Dec. 5, 2016.

(30) Foreign Application Priority Data
Mar. 10, 2016 (CN) 201610139141.0

(51) Int. Cl. G06T 13/40

(52) U.S. Cl. CPC G06T 13/40; G06T 2207/30201

(57) ABSTRACT

A method, apparatus, and computer readable storage medium are provided. The method includes adjusting a first face portion from a first expression to a second expression in a first face model based on an adjustment instruction. A movement trajectory of the first face portion from the first expression to the second expression in the first face model is recorded, and a correspondence between the first face portion and the movement trajectory is recorded. A second face portion that is on a second face model which is different than the first face model and that corresponds to the first face portion is adjusted, based on the movement trajectory and the correspondence between the first face portion and the movement trajectory.

### CROSS-REFERENCE TO RELATED APPLICATIONS

This application is a continuation of International Patent Application No. PCT/CN2016/108591 filed on Dec. 5, 2016, which claims priority to Chinese Patent Application No. 2016101391410, entitled “EXPRESSION ANIMATION GENERATION METHOD AND APPARATUS FOR HUMAN FACE MODEL” filed with the Patent Office of China on Mar. 10, 2016, the disclosures of each of which are incorporated by reference herein in their entirety.

### FIELD

The present disclosure relates to the field of computer technologies, and specifically, to an expression animation generation method and apparatus for a human face model.

### BACKGROUND

Nowadays, to generate an expression animation matching a human face model in a terminal application, a frequently-used technical means is to respectively exploit a set of code to generate corresponding expression animations based on facial characteristics of different human face models. For example, when the expression animation is a dynamic blink, for a human face model with big eyes, the range of opening and closing eyes during blinking is large, and for a human face model with small eyes, the range of opening and closing eyes during blinking is small.

That is, the manner of respectively generating the corresponding expression animations according to the facial characteristics of different human face models not only has a complex operation and increases the difficulty of exploitation, but also has low efficiency of generating the expression animation.

In view of the foregoing problem, at present, no effective solution is provided in the related art.

### SUMMARY

It is an aspect to provide an expression animation generation method and apparatus for a human face model to at least resolve a technical problem of high operation complexity caused by the use of a related art expression animation generation method.

According to an aspect of one or more exemplary embodiments, there is provided a method. The method includes adjusting a first face portion from a first expression to a second expression in a first face model based on an adjustment instruction. A movement trajectory of the first face portion from the first expression to the second expression in the first face model is recorded, and a correspondence between the first face portion and the movement trajectory is recorded. A second face portion that is on a second face model which is different than the first face model and that corresponds to the first face portion is adjusted, based on the movement trajectory and the correspondence between the first face portion and the movement trajectory.

According to other aspects of one or more exemplary embodiments, there are also provided an apparatus and computer readable storage medium consistent with the method.

### BRIEF DESCRIPTION OF THE DRAWINGS

Exemplary embodiments are described herein with reference to the accompanying drawings, in which:

FIG. 1 is a schematic diagram of an application environment of an expression animation generation method for a human face model according to an exemplary embodiment;

FIG. 2 is a flowchart of an expression animation generation method for a human face model according to an exemplary embodiment;

FIG. 3 is a schematic diagram of an expression animation generation method for a human face model according to an exemplary embodiment;

FIG. 4 is a schematic diagram of another expression animation generation method for a human face model according to an exemplary embodiment;

FIG. 5 is a schematic diagram of still another expression animation generation method for a human face model according to an exemplary embodiment;

FIG. 6 is a schematic diagram of still another expression animation generation method for a human face model according to an exemplary embodiment;

FIG. 7 is a schematic diagram of still another expression animation generation method for a human face model according to an exemplary embodiment;

FIG. 8 is a schematic diagram of still another expression animation generation method for a human face model according to an exemplary embodiment;

FIG. 9 is a schematic diagram of an expression animation generation apparatus for a human face model according to an exemplary embodiment;

FIG. 10 is a schematic diagram of an expression animation generation server for a human face model according to an exemplary embodiment; and

FIG. 11 is a schematic diagram of still another expression animation generation method for a human face model according to an exemplary embodiment.

### DETAILED DESCRIPTION

To make a person skilled in the art understand the solutions in the present disclosure better, the following clearly and completely describes the technical solutions in the exemplary embodiments with reference to the accompanying drawings in the exemplary embodiments. The described exemplary embodiments are merely some but not all of the exemplary embodiments. All other exemplary embodiments obtained by a person of ordinary skill in the art based on the exemplary embodiments without creative efforts shall fall within the protection scope of the appended claims.

It should be noted that, in the specification, claims, and accompanying drawings of the present disclosure, the terms “first”, “second”, and the like are intended to distinguish between similar objects rather than describe a specific order or sequence. It should be understood that, data used in this way is exchangeable in a proper case, so that the exemplary embodiments described herein may be implemented in another order except those shown or described herein. In addition, the terms “include”, “contain”, and any other variants mean to cover the non-exclusive inclusion, for example, a process, method, system, product, or device that includes a list of steps or units is not necessarily limited to those units, but may include other units not expressly listed or inherent to such a process, method, system, product, or device.

In the exemplary embodiments, the first expression adjustment instruction used for performing expression adjustment on the first face portion in the plurality of face portions included in the first human face model is obtained. The first face portion in the first human face model is adjusted from the first expression to the second expression in response to the first expression adjustment instruction. In the process of adjusting the first face portion from the first expression to the second expression, the movement trajectory of the first face portion is recorded as the first movement trajectory of the first face portion in the first expression animation generated for the first human face model, and in addition, the correspondence between the first face portion and the first movement trajectory is recorded, the correspondence being used for adjusting the second face portion, corresponding to the first face portion in the second human face model, from the first expression to the second expression. That is, by adjusting the expression of the first face portion in the first human face model in response to the first expression adjustment instruction, and recording, in the adjustment process, the first movement trajectory of the first face portion in the first expression animation generated for the first human face model and the correspondence between the first face portion and the first movement trajectory, the generated expression animation including the first movement trajectory is directly applied to the second face portion corresponding to the first face portion in the second human face model without being re-exploited for the second human face model to generate an expression animation same as the first human face model. In other words, the second human face model may be animated without first determining a from-expression and a to-expression in the second human face model. In this way, an operation of generating the expression animation is simplified, thereby improving the generation efficiency of the expression animation and further overcoming the problem of high operation complexity of generating the expression animation in related technologies.

Further, an expression animation of the second human face model is generated by recording the correspondence between the first face portion in the first human face model and the first movement trajectory. Such a manner of generating corresponding expression animations based on different human face models by using the correspondences may not only ensure the accuracy of the expression animation generated by each human face model, but also the vividness of the expression animation of the human face model. Therefore, the generated expression animation is enabled to better meet the user requirements, so as to achieve an object of improving the user experience.

### Exemplary Embodiment 1

According to the exemplary embodiments, an exemplary embodiment of an expression animation generation method for a human face model is provided. An application client installed on a terminal obtains a first expression adjustment instruction, the first expression adjustment instruction being used for performing expression adjustment on a first face portion in a plurality of face portions included in a first human face model; adjusts the first face portion from a first expression to a second expression in response to the first expression adjustment instruction; and in the process of adjusting the first face portion from the first expression to the second expression, records a movement trajectory of the first face portion as a first movement trajectory of the first face portion in a first expression animation generated for the first human face model, and in addition, records a correspondence between the first face portion and the first movement trajectory, the correspondence being used for adjusting a second face portion, corresponding to the first face portion in a second human face model, from the first expression to the second expression.

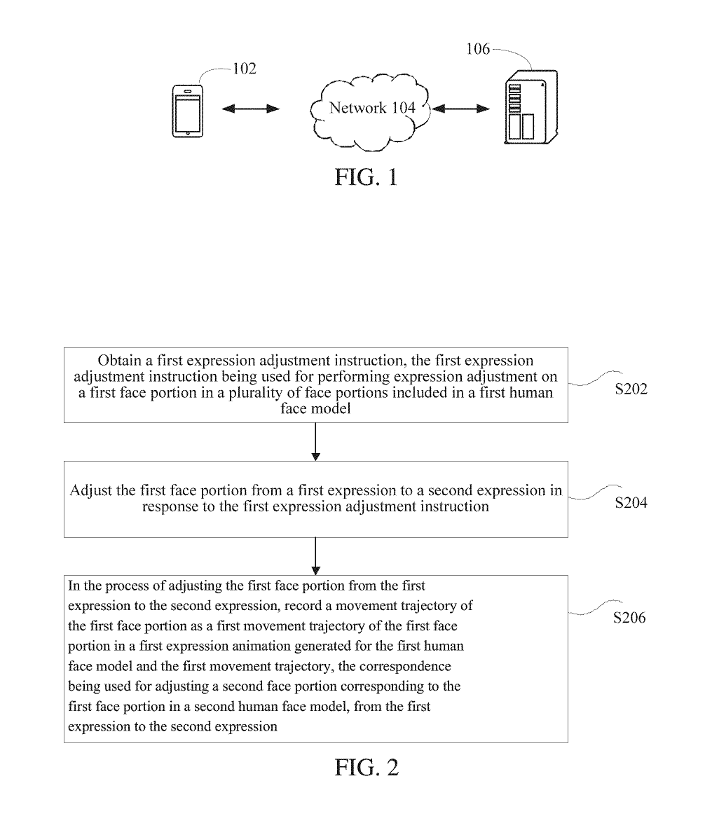

In some exemplary embodiments, the expression animation generation method for a human face model may be, but is not limited to being applied to an application environment shown in FIG. 1. The terminal 102 may send, to a server 106, the recorded first movement trajectory of the first face portion in the first expression animation and the correspondence between the first face portion and the first movement trajectory through a network 104.

It should be noted that, in this exemplary embodiment, the terminal 102 may directly send, to the server 106, one first movement trajectory of the first face portion in the first expression animation and the correspondence between the first face portion and the first movement trajectory after one first movement trajectory of the first face portion in the first expression animation is generated, or may send all movement trajectories and related correspondences to the server 106 after at least one movement trajectory of at least one face portion in a plurality of face portions included by the first expression animation is generated, and the at least one movement trajectory of the at least one face portion includes first movement trajectory of the first face portion.

In some exemplary embodiments, the terminal may include, but is not limited to, at least one of the following: a mobile phone, a tablet computer, a notebook computer, and a PC. The foregoing is merely an example and no limitation is set thereto in this exemplary embodiment.

According to this exemplary embodiment, an expression animation generation method for a human face model is provided. As shown in FIG. 2, the method includes:

S202: Obtain a first expression adjustment instruction, the first expression adjustment instruction being used for performing expression adjustment on a first face portion in a plurality of face portions included in a first human face model.

S204: Adjust the first face portion from a first expression to a second expression in response to the first expression adjustment instruction.

S206: In the process of adjusting the first face portion from the first expression to the second expression, record a movement trajectory of the first face portion as a first movement trajectory of the first face portion in a first expression animation generated for the first human face model, and record a correspondence between the first face portion and the first movement trajectory, the correspondence being used for adjusting a second face portion, corresponding to the first face portion in a second human face model, from the first expression to the second expression.

In some exemplary embodiments, the expression animation generation method for a human face model may be applied to, but is not limited to, a process of creating a character in a terminal application to generate an expression animation of a human face model corresponding to the character. For example, using a game application installed on the terminal as an example, when a character in the game application is created for a player, the expression animation generation method for a human face model may be used to generate a corresponding expression animation set for the character. The expression animation set may include, but is not limited to, one or more expression animations matching the human face model. Therefore, when joining the game application by using a corresponding character, the player may quickly and accurately call the generated expression animation.

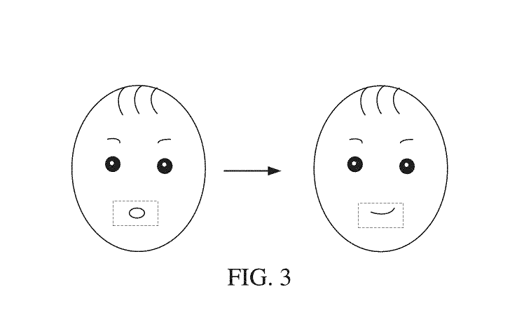

For example, assuming that the schematic diagram shown in FIG. 3 is used as an example for description, an expression adjustment instruction is obtained, and the expression adjustment instruction is used for performing expression adjustment on a lip portion of a plurality of face portions in the human face model, for example, expression adjustment from mouth open to mouth closed. The lip portion is adjusted from a first expression of mouth open (a dashed block shown at the left of FIG. 3) to a second expression of mouth closed (a dashed block shown at the right of FIG. 3) in response to the expression adjustment instruction, and a movement trajectory of the lip portion is recorded as a first movement trajectory in the process of adjusting the lip portion from mouth open to mouth closed, and in addition, a correspondence between the lip portion and the first movement trajectory is recorded, so as to apply the correspondence to an expression animation generation process of a human face model corresponding to another character. The foregoing is merely an example and no limitation is set thereto in this exemplary embodiment.

It should be noted that, in this exemplary embodiment, the first expression adjustment instruction used for performing expression adjustment on the first face portion in the plurality of face portions included in the first human face model is obtained. The first face portion in the first human face model is adjusted from the first expression to the second expression in response to the first expression adjustment instruction. In the process of adjusting the first face portion from the first expression to the second expression, the movement trajectory of the first face portion is recorded as the first movement trajectory of the first face portion in the first expression animation generated for the first human face model. In addition, the correspondence between the first face portion and the first movement trajectory is recorded, the correspondence being used for adjusting the second face portion, corresponding to the first face portion in the second human face model, from the first expression to the second expression. That is, by adjusting the expression of the first face portion in the first human face model in response to the first expression adjustment instruction, and recording, in the adjustment process, the first movement trajectory of the first face portion in the first expression animation generated for the first human face model and the correspondence between the first face portion and the first movement trajectory, the generated expression animation including the first movement trajectory is directly applied to the second face portion corresponding to the first face portion in the second human face model without being re-exploited for the second human face model to generate an expression animation same as the first human face model. In this way, an operation of generating the expression animation is simplified, thereby improving the generation efficiency of the expression animation and further overcoming the problem of high operation complexity of generating the expression animation in the related technologies.

Further, an expression animation of the second human face model is generated by recording the correspondence between the first face portion in the first human face model and the first movement trajectory. Such a manner of generating corresponding expression animations based on different human face models by using the correspondences may not only ensure the accuracy of the expression animation generated by each human face model, but also the vividness and consistency of the expression animation of the human face model. Therefore, the generated expression animation is enabled to better meet the user requirements, so as to achieve an object of improving the user experience.

In some exemplary embodiments, the first expression animation generated in the process of adjusting from the first expression to the second expression includes at least one movement trajectory of at least one face portion in the plurality of face portions, and the at least one movement trajectory of the at least one face portion includes the first movement trajectory of the first face portion.

It should be noted that, in this exemplary embodiment, the first expression animation may be formed by at least one movement trajectory of a same face portion. A plurality of movement trajectories of the same face portion may include, but is not limited to, at least one of the following: a same movement trajectory repeated a plurality of times and different movement trajectories. For example, from eyes open to eyes closed, and then from eyes closed to eyes open, the movement trajectory repeated a plurality of times corresponds to an expression animation: blink. In addition, the first expression animation may alternatively be formed by at least one movement trajectory of different face portions. For example, two movement trajectories, from eyes closed to eyes open and mouth closed to mouth open, starting at the same time correspond to the expression animation: surprise.

In some exemplary embodiments, the first face portion in the first human face model and the second face portion in the second human face model may be, but are not limited to, corresponding face portions in a human face. A second expression animation generated at the second face portion of the second human face model may be, but is not limited to corresponding to the first expression animation.

It should be noted that, in this exemplary embodiment, the first human face model and the second human face model may be, but are not limited to, preset basic human face models in the terminal application. No limitation is set thereto in this exemplary embodiment.

Further, at least one movement trajectory in the first expression animation is the same as a movement trajectory corresponding to the at least one movement trajectory in the second expression animation; and a first display manner of the at least one movement trajectory when the first expression animation is displayed is the same as a second display manner of the movement trajectory corresponding to the at least one movement trajectory in the second expression animation when the second expression animation is displayed. In this exemplary embodiment, the display manners may include, but are not limited to, at least one of the following: a display order, a display time, and a display starting time point.

For example, a first expression animation (for example, the expression animation of mouth open to mouth closed shown in FIG. 3) of the lip portion is generated in the first human face model. By using the expression animation generation method, the recorded correspondence between the lip portion in the first human face model and a movement trajectory of the lip potion in the first expression animation may be used to directly map the first expression animation to the lip portion in the second human face model to generate a second expression animation, so as to generate the second expression animation of the second human face model by directly using the recorded movement trajectory and achieve an object of simplifying an operation of generating the expression animation.

In addition, it should be noted that, in this exemplary embodiment, the specific process of adjusting from the first expression to the second expression may be, but is not limited to being pre-stored in a backend. Specific control code correspondingly stored in the backend is directly called when a corresponding expression animation from the first expression to the second expression is generated. No limitation is set thereto in this exemplary embodiment.

In some exemplary embodiments, adjusting from the first expression to the second expression may be, but is not limited to being controlled by using preset expression control areas being respectively corresponding to the plurality of face portions. Each face portion corresponds to one or more expression control areas, and a control point in the expression control area at different positions in the expression control area corresponds to different expressions of a face portion corresponding to the expression control area.

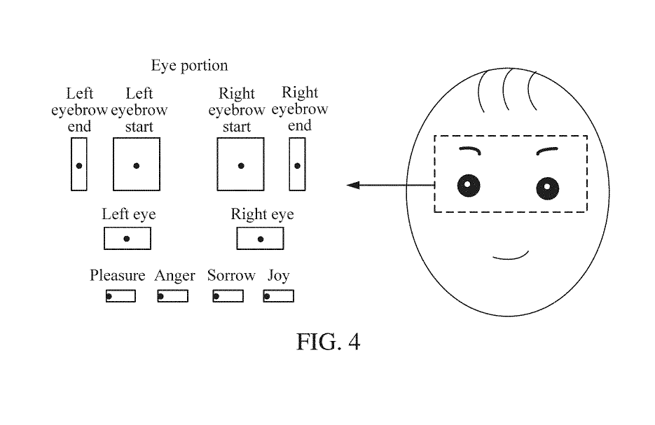

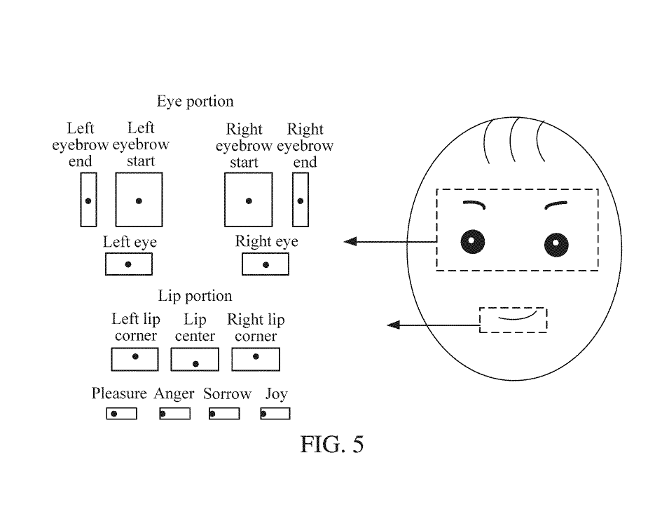

For example, as shown in FIG. 4, an eye portion is used as an example. The eye portion includes a plurality of expression control areas, for example, a left eyebrow start, a left eyebrow end, a right eyebrow start, a right eyebrow end, a left eye, and a right eye. A control point is set in each expression control area, and when being at different positions in the expression control area, the control point corresponds to different expressions.

It should be noted that, in this exemplary embodiment, a control manner of the control point may include, but is not limited to, at least one of the following: directly adjusting the position of the control point in the expression control area, adjusting a progress bar corresponding to the expression control area, and controlling with one click.

The manner of adjusting the progress bar may be, but is not limited to, setting a corresponding progress bar for each expression control area. For example, when the expression animation “blink” is generated, the progress bar may be dragged back and forth to control the eyes to open and close for a plurality of times.

The one-click control may, but is not limited to, directly control a progress bar of a common expression to adjust the positions of the control points that are in the expression control areas and that are of the plurality of face portions of the human face.

In some exemplary embodiments, after the correspondence between the first face portion and the first movement trajectory is recorded, face adjustment may be performed on the first human face model according to, but is not limited to, an adjustment instruction input by a user to obtain a human face model meeting the user requirements. That is, in this exemplary embodiment, the face portions of the first human face model may be adjusted to obtain a special human face model different from the basic human face model (for example, the first human face model and the second human face model). It should be noted that, in this exemplary embodiment, the foregoing process may alternatively be referred to as face sculpting. The special human face model meeting personal requirements and preference of the user is obtained by sculpting a face.

In some exemplary embodiments, adjusting the first human face model may be, but is not limited to, determining a to-be-operated face portion in the plurality of face portions of the human face model according to a position of a cursor detected in the first human face model and editing the to-be-operated face portion, so as to directly edit the first human face model by using a face picking technology.

It should be noted that, the determining a to-be-operated face portion in the plurality of face portions of the human face model may include, but is not limited to, determining according to a color value of a pixel at the position of the cursor. The color value of the pixel includes one of the following: a red color value of the pixel, a green color value of the pixel, and a blue color value of the pixel. For example, in the human face model shown in Table 1, a nose specifically includes six detailed portions, and for each detailed portion, a red color value is set (indicated by an R color value).

TABLE 1

| Position of the human | Name of a detailed | R color |
|---|---|---|
| face model | portion | value |
| Nose | Entire nose | 230 |
| | Nasal root | 210 |
| | Nasal bridge | 200 |
| | Nasal tip | 190 |
| | Nasal base | 180 |
| | Ala of the nose | 170 |

That is, the determining a to-be-operated face portion in the plurality of face portions of the human face model may include, but is not limited to, after the color value of the pixel of the position of the cursor is determined, obtaining a face portion corresponding to the color value of the pixel by query a pre-stored mapping relationship between color values and face portions (as shown in Table 1), so as to obtain a corresponding to-be-operated face portion.

It should be noted that, a position difference exists between each face portion in the special human face model obtained after adjusting the first human face model and each face portion of the basic human face model. That is, if an expression animation generated according to the basic human face model is directly applied to the special human face model, a problem that a change of the position of the expression animation is inaccurate and the vividness of the expression animation is further affected may be caused.

In view of this, this exemplary embodiment may further include, but is not limited to, mapping the movement trajectory in the expression animation generated based on the first human face model to an adjusted human face model, so as to obtain a movement trajectory in a movement trajectory matching the adjusted human face model. In this way, for the special human face model, the accuracy and vividness of the generated expression animation is ensured.

In some exemplary embodiments, the foregoing expression animation generation method for a human face model may, but is not limited to, use a morpheme engine used for blending a correlation between the animations to achieve an object of perfectly combining the expression animation with face adjustment. In this way, not only may a shape of facial features of a character in the game be changed, but also enable the facial features whose shape is changed to be normal and a corresponding facial expression animation is vividly and naturally played. In this way, problems, for example, stiffness, excessiveness, distortion, and unnaturalness of the expression animation caused because the morpheme engine is not used in the expression animation in the related technologies and an interlude phenomenon or a lack of a lifelike effect because of the change of the shape of the facial features are overcome. Further, natural and vivid playing and the expression animation corresponding to the human face are implemented.

According to this exemplary embodiment provided by this application, by adjusting the expression of the first face portion in the first human face model in response to the first expression adjustment instruction, and recording, in the adjustment process, the first movement trajectory of the first face portion in the first expression animation generated for the first human face model and the correspondence between the first face portion and the first movement trajectory, the generated expression animation including the first movement trajectory is directly applied to the second face portion corresponding to the first face portion in the second human face model without being re-exploited for the second human face model to generate an expression animation same as the first human face model. In this way, an operation of generating the expression animation is simplified, thereby improving the generation efficiency of the expression animation and further overcoming the problem of high operation complexity of generating the expression animation in the related technologies.

In some exemplary embodiments, after the recording a correspondence between the first face portion and the first movement trajectory, the method further includes:

S1: Obtain a second expression adjustment instruction, the second expression adjustment instruction being used for at least performing expression adjustment on the second face portion in the second human face model.

S2: Obtain the correspondence between the first face portion and the first movement trajectory.

S3: Record the first movement trajectory indicated by the correspondence as a second movement trajectory of the second face portion in a second expression animation generated for the second human face model.

It should be noted that, in this exemplary embodiment, after the correspondence between the first face portion and the first movement trajectory is recorded, in the process of generating the second expression animation of the second face portion corresponding to the first face portion in the second human face model, the generated correspondence between the first face portion and the first movement trajectory may be, but is not limited to being recorded as the second movement trajectory of the second face portion in the second expression animation. That is, a movement trajectory corresponding to a new human face model is directly generated by using the generated movement trajectory without being re-exploited for the new human face model, so as to simplify an operation of regenerating the movement trajectory and improve the efficiency of generating the expression animation.

It should be noted that, in this exemplary embodiment, the first human face model and the second human face model may be, but are not limited to, the preset basic human face models in the terminal application. Therefore, in the process of generating the expression animation, the movement trajectory of the face portion in the expression animation generated in the first human face model may be directly applied to the second human face model.

Descriptions are specifically made with reference to the following examples. Assuming that the first face portion of the first human face model (for example, an ordinary woman) is the eye portion, and the first movement trajectory in the first expression animation is blinking, after the second expression adjustment instruction is obtained, assuming that the expression adjustment, indicated by the second expression adjustment instruction, performed on the second face portion (for example, which is also the eye portion) of the second human face model (for example, an ordinary man) is also blinking, in this way, a correspondence between the eye portion and the first movement trajectory of blinking when the ordinary woman blinks may be obtained. Further, the first movement trajectory indicated by the correspondence is recorded as the second movement trajectory of the eye portion of the ordinary man. That is, the movement trajectory of blinking of the ordinary woman is applied to the movement trajectory of blinking of the ordinary man, so as to achieve an object of simplifying the generation operation.

According to this exemplary embodiment provided by this application, after obtaining the second expression adjustment instruction used for at least performing expression adjustment on the second face portion in the second human face model, the correspondence between the first face portion and the first movement trajectory may be obtained. By recording the first movement trajectory indicated by the correspondence as the second movement trajectory, an object of simplifying the generation operation is achieved, avoiding individually exploiting a set of code for generating the expression animation for the second human face model. In addition, the consistency and vividness of the expression animations of different human face models are ensured.

In some exemplary embodiments,

before the obtaining a first expression adjustment instruction, the method further includes: S1: Respectively set expression control areas for the plurality of face portions included in the first human face model, each face portion in the plurality of face portions being corresponding to one or more expression control areas, and a control point in the expression control area at different positions in the expression control area being corresponding to different expressions of a face portion corresponding to the expression control area; and

the obtaining a first expression adjustment instruction includes: S2: Detect a control point moving operation, the control point moving operation being used for moving the control point, in a first expression control area corresponding to the first face portion in the expression control area, from a first position to a second position; and S3: Obtain the first expression adjustment instruction generated in response to the control point moving operation, the first position being corresponding to the first expression and the second position being corresponding to the second expression.

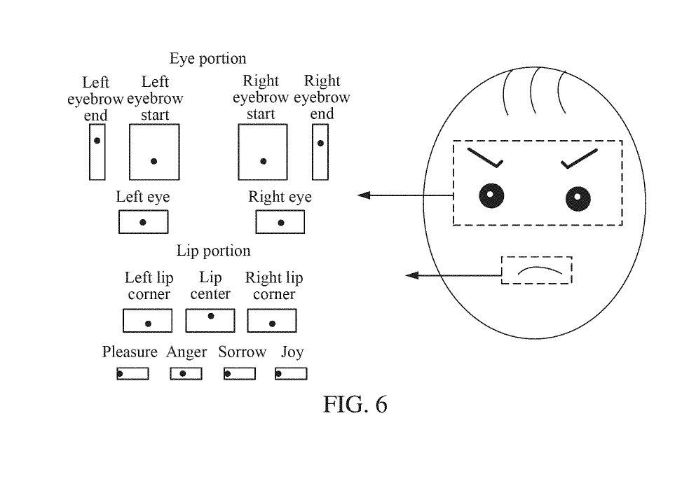

Descriptions are specifically made with reference to FIG. 5. Before the first expression adjustment instruction is obtained, the expression control areas are set for the plurality of face portions included in the first human face model. Using the schematic diagram shown in FIG. 5 as an example, a plurality of expression control areas are set for the eye portion, for example, the left eyebrow start, the left eyebrow end, the right eyebrow start, the right eyebrow end, the left eye, and the right eye. A plurality of expression control areas are set for the lip portion, for example, a left lip corner, a lip center, and a right lip corner. A control point is respectively set in each expression control area, and the control point at different positions in the expression control area corresponds to different expressions. Referring to FIG. 5 and FIG. 6, when each control point is at the first position in the expression control area shown in FIG. 5, the first expression (for example, smile) is displayed, and when the position of the control point changes to the second position in the expression control area shown in FIG. 6, the second expression (for example, anger) is displayed.

It should be noted that, a progress bar of the “anger” expression may further be dragged herein to adjust an expression to the expression shown in FIG. 6 at a time. The position of the control point in each expression control area also correspondingly changes to the second position shown in FIG. 6.

Further, in this exemplary embodiment, when each control point in the corresponding expression control point is detected to move from the first position shown in FIG. 5 to the second position shown in FIG. 6, the first expression adjustment instruction generated in response to a moving operation of the control point may be obtained. For example, the first expression adjustment instruction is used for instructing to adjust from the first expression “smile” to the second expression “anger”.

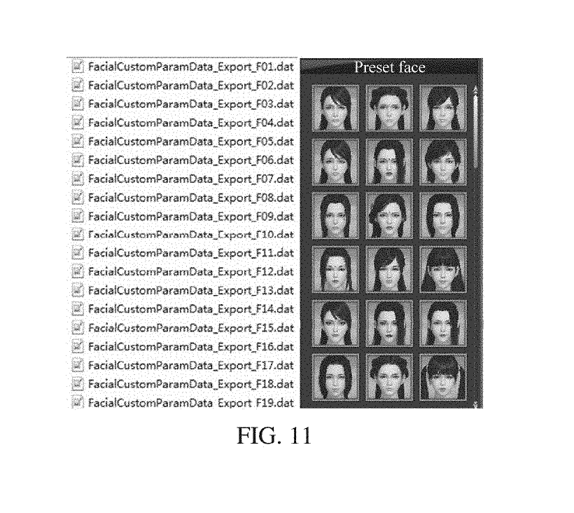

In some exemplary embodiments, the number of the control points may be, but is not limited to, set to 26. Each control point has coordinate axial directions of three dimensions of X, Y, and Z. Each axial direction is provided with three types of parameters, for example, a displacement parameter, a rotation parameter, and a zooming in or out parameter. Each type of parameter has an independent value range. These parameters may control an adjustment range of facial expressions, so as to ensure richness of the expression animation. These parameters may be, but is not limited to being derived in a dat format and an effect is shown in FIG. 11.

According to this exemplary embodiment provided by this application, by respectively setting expression control areas for the plurality of face portions, the control point in the expression control area at different positions in the expression control area being corresponding to different expressions of a face portion corresponding to the expression control area, a corresponding expression adjustment instruction is obtained by detecting whether the position of the control point in the expression control area is moved. In this way, a facial expression change in the human face model is quickly and accurately obtained, further ensuring the generation efficiency of the expression animation in the human face model. In addition, by controlling different expressions by using the control points, an adjustment operation on an expression in the human face model is simplified and expression changes of the human face model are enabled to be richer and more vivid, so as to achieve an object of improving the user experience.

In some exemplary embodiments, the recording a correspondence between the first face portion and the first movement trajectory includes:

S1: Record the first expression control area corresponding to the first face portion and a correspondence, used for indicating the first movement trajectory, between the first position and the second position.

Descriptions are specifically made with reference to the following examples. It is assumed that the first face portion uses the lip potion shown in FIG. 5 and FIG. 6 as an example. In the process of adjusting from the first expression shown in FIG. 5 to the second expression shown in FIG. 6, recording a correspondence between the first movement trajectory in the generated first expression animation and the lip portion may be recording a correspondence between the first position shown in FIG. 5 (that is, the control point of the lip center shown in FIG. 5 is near the top and the control points in the left lip corner and the right lip corner are near the bottom) and the second position shown in FIG. 6 (that is, the control points in the left lip corner and the right lip corner shown in FIG. 6 move downward, and the control point of the lip center moves upward) of the control points in the first expression control area (that is, the left lip corner, the lip center, and the right lip corner) corresponding to the lip portion.

It should be noted that, in this exemplary embodiment, a specific process of the control points moving from the first position to the second position according to the first movement trajectory may be, but is not limited to being pre-stored in the backend. A corresponding first movement trajectory may be directly obtained when the correspondence between the first position and the second position is obtained. No limitation is set thereto in this exemplary embodiment.

According to this exemplary embodiment provided by this application, by recoding the correspondence between the first expression control area corresponding to the first face portion and the first position and the second position toward which the first movement trajectory used for indicating movement of the control point moves, it is convenient to directly generate a corresponding movement trajectory according to the position relationship, so as to generate a corresponding expression animation to overcome the problem of high operation complexity of generating the expression animation in the related technologies.

In some exemplary embodiments, after the recording a correspondence between the first face portion and the first movement trajectory, the method further includes:

S1: Detect a position of a cursor in the first human face model, the human face model including the plurality of face portions.

S2: Determine a to-be-operated face portion in the plurality of face portions according to the position.

S3: Detect a selecting operation on the to-be-operated face portion.

S4: Edit the to-be-operated face portion in response to an obtained editing operation on the to-be-operated face portion to obtain an edited face portion.

S5: Display the edited face portion in the first human face model.

In some exemplary embodiments, after the correspondence between the first face portion and the first movement trajectory is recorded, face adjustment may be performed on the to-be-operated face portions in the plurality of face portions the first human face model according to, but is not limited to, an adjustment instruction input by a user to obtain a human face model meeting the user requirements. That is, in this exemplary embodiment, the face portions of the first human face model may be adjusted to obtain a special human face model different from the basic human face model (for example, the first human face model and the second human face model). It should be noted that, in this exemplary embodiment, the foregoing process may alternatively be referred to as face sculpting. The special human face model meeting personal requirements and preference of the user is obtained by sculpting a face.

In some exemplary embodiments, adjusting the first human face model may be, but is not limited to, according to a position of a cursor detected in the first human face model, determining a to-be-operated face portion in the plurality of face portions of the human face model and editing the to-be-operated face portion, so as to directly edit the first human face model by using a face picking technology to obtain an edited face portion. Further, the edited face portion is displayed in the first human face model, that is, the special human face model obtained after face sculpting.

According to this exemplary embodiment provided by this application, by detecting the position of the cursor to determine the selected to-be-operated face portion in the plurality of face portions of the human face model, it is convenient to directly implement the editing process of the to-be-operated face portion without dragging a corresponding slider in an additional control list. The user is enabled to directly perform face picking editing on the human face model, so as to simplify the editing operation on the human face model.

In some exemplary embodiments, the to-be-operated face portion is the first face portion, the first face portion is an eye portion, the first movement trajectory in the first expression animation includes a first blinking movement trajectory of the eye portion, and the first blinking movement trajectory starts from a first static eye open angle of the eye portion.

Editing the to-be-operated face portion in response to an obtained editing operation on the to-be-operated face portion includes: S1: Adjust the first static eye open angle of the eye portion to a second static eye open angle.

After the to-be-operated face portion is edited in response to an obtained editing operation on the to-be-operated face portion, the solution further includes: S2: Map the first movement trajectory in the first expression animation to a second blinking movement trajectory according to the first static eye open angle and the second static eye open angle.

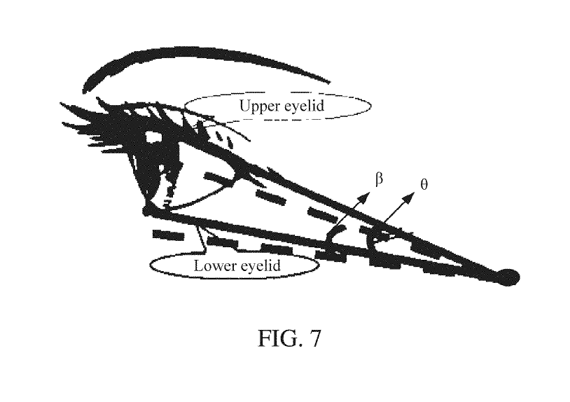

Descriptions are specifically made with reference to the following examples. It is assumed that the to-be-operated face portion is the first face portion, the first face portion is the eye portion, the first movement trajectory in the first expression animation includes the first blinking movement trajectory of the eye portion, and the first blinking movement trajectory starts from the first static eye open angle of the eye portion. The first static eye open angle is β as shown in FIG. 7.

For example, the obtained editing operation on the eye portion is adjusting the first static eye open angle β of the eye portion to the second static eye open angle θ, as shown in FIG. 7. Further, the first movement trajectory in the first expression animation is mapped to the second blinking movement trajectory according to the first static eye open angle β and the second static eye open angle θ. That is, the first blinking movement trajectory is adjusted based on the second static eye open angle θ to obtain, through mapping, the second blinking movement trajectory.

In some exemplary embodiments, the morpheme engine may be, but is not limited to being used to perform adjustment on the to-be-operated face portion (for example, the eye portion). In the entire expression animation generation process (for example, blinking) of the human face model, in this exemplary embodiment, a normal expression animation is blended with human face bones. That is, the face bone is multiplied by the normal animation, and a bone required by the face is maintained and then is blended with all normal bone animations. In this way, in the process of generating the expression animation, after the size of the eye portion in changed, the expression animation of the eye portion may still achieve an effect of closing, and further, the expression animation of the to-be-operated face portion (for example, the eye portion) is normally and naturally played.

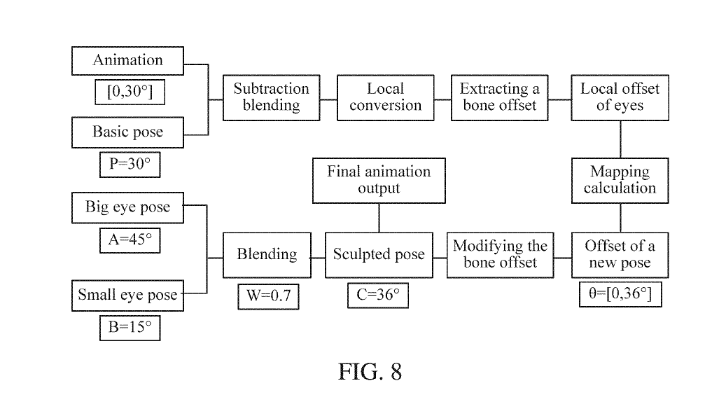

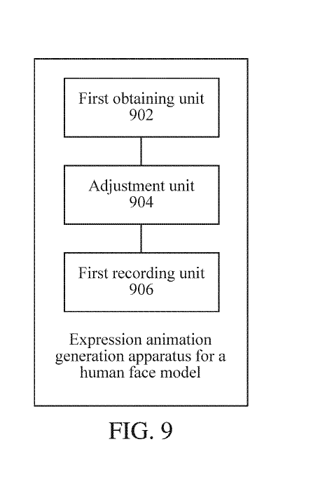

For example, a flow of the expression animation generation is described with reference to FIG. 8: First, the static eye open angle (for example, a big eye pose or a small eye pose) is set, then a bone offset is obtained by blending the expression animation with a basic pose, and a local offset of eyes is further obtained. Subsequently, a mapping calculation is performed on the local offset of the eyes to obtain an offset of a new pose. Finally, the offset of the new pose is applied to the previously-set static eye open angle (for example, the big eye pose or the small eye pose) by modifying the bone offset, so as to obtain a final animation output.

A formula of the mapping calculation is as follows:

λ=P/(A+B)=0.5θ=β*(w+λ)β∈[0,30°]w∈[0,1]

According to this exemplary embodiment provided by this application, after the eye portion is adjusted from the first static eye open angle to the second static eye open angle, the first blinking movement trajectory corresponding to the first static eye open angle is mapped to the second blinking movement trajectory, so that it is ensured that the special human face model different from the basic human face model may accurately and vividly implement blinking, avoiding a problem that the eyes cannot close or excessively close.

In some exemplary embodiments, the mapping the first movement trajectory in the first expression animation to the second blinking movement trajectory according to the first static eye open angle and the second static eye open angle includes:

θ=β*(w+λ) (1)

λ=P/(A+B) (2)

where θ is an angle between an upper eyelid and a lower eyelid in the eye portion in the second blinking movement trajectory, β is an angle between the upper eyelid and the lower eyelid in the eye portion in the first blinking movement trajectory, w is a preset value, w∈[0,1], P is the first static eye open angle, A is a maximum angle to which the first static eye open angle is allowed to be adjusted, and B is a minimum angle to which the first static eye open angle is allowed to be adjusted; and

w+λ=the second static eye open angle/the first static eye open angle.

According to this exemplary embodiment of this application, the second blinking movement trajectory obtained by mapping the first blinking movement trajectory may be calculated by the foregoing formula, so that the accuracy and vividness of the expression animation may be ensured at the same time when expression animation generation of the human face model is simplified.

In some exemplary embodiments, the determining a to-be-operated face portion in the plurality of face portions according to the position includes:

S1: Obtain a color value of a pixel at the position.

S2: Determine the to-be-operated face portion corresponding to the color value in the plurality of face portions.

In some exemplary embodiments, the obtaining a color value of a pixel at the position may include, but is not limited to: obtaining a color value that is of a pixel corresponding to the position and that is in a mask map. The mask map is in contact with the human face model and includes a plurality of mask areas in one-to-one correspondence with the plurality of face portions. Each mask area corresponds to one face portion. The color of the pixel may include one of the following: a red color value of the pixel, a green color value of the pixel, and a blue color value of the pixel.

It should be noted that, in this exemplary embodiment, each mask area on the mask map in contact with the human face model is respectively in one-to-one correspondence with one face portion on the human face model. That is, by selecting, by the cursor, the mask area on the mask map in contact with the human face model, the face portion corresponding to the human face model is selected, so that the face portion on the human face model is directly edited, achieving an object of simplifying the editing operation.

For example, refer to Table 1, when the obtained R color value of the pixel of the position of the cursor is 200, a corresponding mask area may be determined by searching a preset mapping relationship, thereby obtaining a to-be-operated face portion corresponding to the mask area, that is, a “nasal bridge”.

According to this exemplary embodiment provided by this application, by the obtained color value of the pixel of the position of the cursor, the to-be-operated face portion corresponding to the color value in the plurality of face portions is determined. That is, the to-be-operated face portion is determined by using the color value of the pixel of the position of the cursor, so that the editing operation may be directly performed on the face portion in the human face model to achieve an object of simplifying the editing operation.

In some exemplary embodiments, the obtaining a color value of a pixel at the position includes:

S1: Obtain the color value that is of a pixel corresponding to the position and that is in a mask map, the mask map being in contact with the human face model and including a plurality of mask areas in one-to-one correspondence with the plurality of face portions, and each mask area being corresponding to one face portion.

The color value of the pixel includes one of the following: the red color value of the pixel, the green color value of the pixel, and the blue color value of the pixel.

Descriptions are specifically made with reference to the following examples. According to the anthropotomy, 48 bones may affect a classification of muscles, so as to obtain a muscle portion control list and set an R color value for each portion. To avoid an error, a minimum of 10 units exists between each value. Further, according to a distribution status of these portions on the human face, a mask map corresponding to the human face model may be obtained by using the R color values corresponding to these portions. Table 1 shows the R color values of the nose portion in the human face model.

That is, the mask map corresponding to the human face model may be drawn according to the R color value in the mapping relationship. The mask map is in contact with the human face model and the plurality of mask areas included by the mask map is in one-to-one correspondence with the plurality of face portions.

According to this exemplary embodiment provided by this application, the corresponding color value of the pixel is obtained by referring to the mask map in contact with the human face model, so that the color value of the pixel of the position of the cursor is accurately obtained and a corresponding to-be-operated face portion is obtained according to the color value.

In some exemplary embodiments, before the detecting a position in the displayed human face model of a cursor, the method further includes:

S1: Display the human face model and the generated mask map, the mask map being set as to be in contact with the human face model.

According to this exemplary embodiment provided by this application, before the position in the displayed human face model of the cursor is detected, an image combined by the human face model and the generated mask map is displayed in advance, so that when the position of the cursor is detected, a corresponding position may be directly and quickly obtained by using the mask map. Further, the to-be-operated face portion in the plurality of face portions of the human face model is accurately obtained and an object of improving the editing efficiency is achieved.

In some exemplary embodiments, when the selecting operation on the to-be-operated face portion is detected, the method further includes:

S1: Highlight the to-be-operated face portion in the human face model.

In some exemplary embodiments, when the selecting operation on the to-be-operated face portion is detected, the solution may include, but is not limited to, specially displaying on the to-be-operated face portion. For example, the face portion is highlighted, shadow is displayed at the face portion, or the like. No limitation is set thereto in this exemplary embodiment.

According to this exemplary embodiment provided by this application, by highlighting the to-be-operated face portion, the user is enabled to intuitively see the editing operation performed on the face portion in the human face model, so as to implement what a person sees is what the person gets. In this way, the editing operation may be closer to the user requirements and the user experience is improved.

In some exemplary embodiments, the editing the to-be-operated face portion in response to an obtained editing operation on the be-operated face portion to obtain an edited face portion includes at least one of the following:

S1: Move the to-be-operated face portion.

S2: Rotate the to-be-operated face portion.

S3: Zoom in the to-be-operated face portion.

S4: Zoom out the to-be-operated face portion.

In some exemplary embodiments, a manner of implementing the foregoing editing operation may be, but is not limited to at least one of the following: clicking and dragging. That is, by using a combination of different operation manners, at least one of the following editing is performed on the to-be-operated face portion: moving, rotating, zooming in, and zooming out.

According to this exemplary embodiment provided by this application, different types of editing is performed on the to-be-operated face portion on the human face model, so that the editing operation is simplified, the editing efficiency is improved, and the problem of high operation complexity in the related technologies is overcome.

It should be noted that, for simple description, the foregoing method exemplary embodiments are represented as a series of actions, but a person skilled in the art should appreciate that the present disclosure is not limited to the described order of the actions because some steps may be performed in another order or performed simultaneously according to the present disclosure. In addition, a person skilled in the art should also know that all the exemplary embodiments described in this specification are merely exemplary embodiments, and the related actions and modules are not necessarily required in the present disclosure.

Through the foregoing description of the implementations, it is clear to a person skilled in the art that the present disclosure may be implemented by software plus a necessary universal hardware platform, and certainly may also be implemented by hardware. Based on such an understanding, the technical solutions of the present disclosure or the part that makes contributions to the related technology may be substantially embodied in the form of a software product. The computer software product is stored in a storage medium (for example, a ROM/RAM, a magnetic disk, or an optical disc), and contains several instructions for instructing a terminal device (which may be a mobile phone, a computer, a server, or a network device) to perform the method according to the exemplary embodiments.

### Exemplary Embodiment 2

According to the exemplary embodiments, an expression animation generation apparatus for a human face model used for implementing the foregoing expression animation generation method for a human face model is provided, as shown in FIG. 9, the apparatus includes:

1) a first obtaining unit 902, configured to obtain a first expression adjustment instruction, the first expression adjustment instruction being used for performing expression adjustment on a first face portion in a plurality of face portions included in a first human face model;

2) an adjustment unit 904, configured to respond to the first expression adjustment instruction to adjust the first face portion from a first expression to a second expression; and

3) a first recording unit 906, configured to: in the process of adjusting the first face portion from the first expression to the second expression, record a movement trajectory of the first face portion as a first movement trajectory of the first face portion in a first expression animation generated for the first human face model, and record a correspondence between the first face portion and the first movement trajectory, the correspondence being used for adjusting a second face portion, corresponding to the first face portion in a second human face model, from the first expression to the second expression

In some exemplary embodiments, the expression animation generation apparatus for a human face model may be applied to, but is not limited to, a process of creating a character in a terminal application to generate an expression animation of a human face model corresponding to the character. For example, using a game application installed on the terminal as an example, when a character in the game application is created for a player, the expression animation generation apparatus for a human face model may be used to generate a corresponding expression animation set for the character. The expression animation set may include, but is not limited to, one or more expression animations matching the human face model. Therefore, when joining the game application by using a corresponding character, the player may quickly and accurately call the generated expression animation.

For example, assuming that the schematic diagram shown in FIG. 3 is used as an example for description, an expression adjustment instruction is obtained, and the expression adjustment instruction is used for performing expression adjustment on a lip portion of a plurality of face portions in the human face model, for example, expression adjustment from mouth open to mouth closed. The lip portion is adjusted from a first expression of mouth open (a dashed block shown at the left of FIG. 3) to a second expression of mouth closed (a dashed block shown at the right of FIG. 3) in response to the expression adjustment instruction, and a movement trajectory of the lip portion is recorded as a first movement trajectory in the process of adjusting the lip portion from mouth open to mouth closed, and in addition, a correspondence between the lip portion and the first movement trajectory is recorded, so as to apply the correspondence to an expression animation generation process of a human face model corresponding to another character. The foregoing is merely an example and no limitation is set thereto in this exemplary embodiment.

It should be noted that, in this exemplary embodiment, the first expression adjustment instruction used for performing expression adjustment on the first face portion in the plurality of face portions included in the first human face model is obtained. The first face portion in the first human face model is adjusted from the first expression to the second expression in response to the first expression adjustment instruction. In the process of adjusting the first face portion from the first expression to the second expression, the movement trajectory of the first face portion is recorded as the first movement trajectory of the first face portion in the first expression animation generated for the first human face model. In addition, the correspondence between the first face portion and the first movement trajectory is recorded, the correspondence being used for adjusting the second face portion, corresponding to the first face portion in the second human face model, from the first expression to the second expression. That is, by adjusting the expression of the first face portion in the first human face model in response to the first expression adjustment instruction, and recording, in the adjustment process, the first movement trajectory of the first face portion in the first expression animation generated for the first human face model and the correspondence between the first face portion and the first movement trajectory, the generated expression animation including the first movement trajectory is directly applied to the second face portion corresponding to the first face portion in the second human face model without being re-exploited for the second human face model to generate an expression animation same as the first human face model. In this way, an operation of generating the expression animation is simplified, thereby improving the generation efficiency of the expression animation and further overcoming the problem of high operation complexity of generating the expression animation in the related technologies.

Further, an expression animation of the second human face model is generated by recording the correspondence between the first face portion in the first human face model and the first movement trajectory. Such a manner of generating corresponding expression animations based on different human face models by using the correspondences may not only ensure the accuracy of the expression animation generated by each human face model, but also the vividness and consistency of the expression animation of the human face model. Therefore, the generated expression animation is enabled to better meet the user requirements, so as to achieve an object of improving the user experience.

In some exemplary embodiments, the first expression animation generated in the process of adjusting from the first expression to the second expression includes at least one movement trajectory of at least one face portion in the plurality of face portions, and the at least one movement trajectory of the at least one face portion includes the first movement trajectory of the first face portion.

It should be noted that, in this exemplary embodiment, the first expression animation may be formed by at least one movement trajectory of a same face portion. A plurality of movement trajectories of the same face portion may include, but is not limited to, at least one of the following: a same movement trajectory repeated a plurality of times and different movement trajectories. For example, from eyes open to eyes closed, and then from eyes closed to eyes open, the movement trajectory repeated a plurality of times corresponds to an expression animation: blink. In addition, the first expression animation may alternatively be formed by at least one movement trajectory of different face portions. For example, two movement trajectories, from eyes closed to eyes open and mouth closed to mouth open, starting at the same time correspond to the expression animation: surprise.

In some exemplary embodiments, the first face portion in the first human face model and the second face portion in the second human face model may be, but are not limited to, corresponding face portions in a human face. A second expression animation generated at the second face portion of the second human face model may be, but is not limited to corresponding to the first expression animation.

It should be noted that, in this exemplary embodiment, the first human face model and the second human face model may be, but are not limited to, the preset basic human face models in the terminal application. No limitation is set thereto in this exemplary embodiment.

Further, at least one movement trajectory in the first expression animation is the same as a movement trajectory corresponding to the at least one movement trajectory in the second expression animation; and a first display manner of the at least one movement trajectory when the first expression animation is displayed is the same as a second display manner of the movement trajectory corresponding to the at least one movement trajectory in the second expression animation when the second expression animation is displayed. In this exemplary embodiment, the display manners may include, but are not limited to, at least one of the following: a display order, a display time, and a display starting time point.

For example, a first expression animation (for example, the expression animation of mouth open to mouth closed shown in FIG. 3) of the lip portion is generated in the first human face model. By using the expression animation generation method, the recorded correspondence between the lip portion in the first human face model and a movement trajectory of the lip potion in the first expression animation may be used to directly map the first expression animation to the lip portion in the second human face model to generate a second expression animation, so as to generate the second expression animation of the second human face model by directly using the recorded movement trajectory and achieve an object of simplifying an operation of generating the expression animation.

In addition, it should be noted that, in this exemplary embodiment, the specific process of adjusting from the first expression to the second expression may be, but is not limited to being pre-stored in a backend. Specific control code correspondingly stored in the backend is directly called when a corresponding expression animation from the first expression to the second expression is generated. No limitation is set thereto in this exemplary embodiment.

In some exemplary embodiments, adjusting from the first expression to the second expression may be, but is not limited to being controlled by using preset expression control areas being respectively corresponding to the plurality of face portions. Each face portion corresponds to one or more expression control areas, and a control point in the expression control area at different positions in the expression control area corresponds to different expressions of a face portion corresponding to the expression control area.

For example, as shown in FIG. 4, an eye portion is used as an example. The eye portion includes a plurality of expression control areas, for example, a left eyebrow start, a left eyebrow end, a right eyebrow start, a right eyebrow end, a left eye, and a right eye. A control point is set in each expression control area, and when being at different positions in the expression control area, the control point corresponds to different expressions.

It should be noted that, in this exemplary embodiment, a control manner of the control point may include, but is not limited to, at least one of the following: directly adjusting the position of the control point in the expression control area, adjusting a progress bar corresponding to the expression control area, and controlling with one click.

The manner of adjusting the progress bar may be, but is not limited to, setting a corresponding progress bar for each expression control area. For example, when the expression animation “blink” is generated, the progress bar may be dragged back and forth to control the eyes to open and close for a plurality of times.

The one-click control may, but is not limited to, directly control a progress bar of a common expression to adjust the positions of the control points that are in the expression control areas and that are of the plurality of face portions of the human face.

In some exemplary embodiments, after the correspondence between the first face portion and the first movement trajectory is recorded, face adjustment may be performed on the first human face model according to, but is not limited to, an adjustment instruction input by a user to obtain a human face model meeting the user requirements. That is, in this exemplary embodiment, the face portions of the first human face model may be adjusted to obtain a special human face model different from the basic human face model (for example, the first human face model and the second human face model). It should be noted that, in this exemplary embodiment, the foregoing process may alternatively be referred to as face sculpting. The special human face model meeting personal requirements and preference of the user is obtained by sculpting a face.

In some exemplary embodiments, adjusting the first human face model may be, but is not limited to, determining a to-be-operated face portion in the plurality of face portions of the human face model according to a position of a cursor detected in the first human face model and editing the to-be-operated face portion, so as to directly edit the first human face model by using a face picking technology.

It should be noted that, the determining a to-be-operated face portion in the plurality of face portions of the human face model may include, but is not limited to, determining according to a color value of a pixel at the position of the cursor. The color value of the pixel includes one of the following: a red color value of the pixel, a green color value of the pixel, and a blue color value of the pixel. For example, in the human face model shown in Table 1, a nose specifically includes six detailed portions, and for each detailed portion, a red color value is set (indicated by an R color value).

TABLE 2

| Position of the human | Name of a detailed | R color |
|---|---|---|
| face model | portion | value |
| Nose | Entire nose | 230 |
| | Nasal root | 210 |
| | Nasal bridge | 200 |
| | Nasal tip | 190 |
| | Nasal base | 180 |
| | Ala of the nose | 170 |

That is, the determining a to-be-operated face portion in the plurality of face portions of the human face model may include, but is not limited to, after the color value of the pixel of the position of the cursor is determined, obtaining a face portion corresponding to the color value of the pixel by query a pre-stored mapping relationship between color values and face portions (as shown in Table 2), so as to obtain a corresponding to-be-operated face portion.

It should be noted that, a position difference exists between each face portion in the special human face model obtained after adjusting the first human face model and each face portion of the basic human face model. That is, if an expression animation generated according to the basic human face model is directly applied to the special human face model, a problem that a change of the position of the expression animation is inaccurate and the vividness of the expression animation is further affected may be caused.

In view of this, this exemplary embodiment may further include, but is not limited to, mapping the movement trajectory in the expression animation generated based on the first human face model to an adjusted human face model, so as to obtain a movement trajectory in a movement trajectory matching the adjusted human face model. In this way, for the special human face model, the accuracy and vividness of the generated expression animation is ensured.

In some exemplary embodiments, the foregoing expression animation generation method for a human face model may, but is not limited to, use a morpheme engine used for blending a correlation between the animations to achieve an object of perfectly combining the expression animation with face adjustment. In this way, not only may a shape of facial features of a character in the game be changed, but also enable the facial features whose shape is changed to be normal and a corresponding facial expression animation is vividly and naturally played. In this way, problems, for example, stiffness, excessiveness, distortion, and unnaturalness of the expression animation caused because the morpheme engine is not used in the expression animation in the related technologies and an interlude phenomenon or a lack of a lifelike effect because of the change of the shape of the facial features are overcome. Further, natural and vivid playing and the expression animation corresponding to the human face are implemented.

According to this exemplary embodiment provided by this application, by adjusting the expression of the first face portion in the first human face model in response to the first expression adjustment instruction, and recording, in the adjustment process, the first movement trajectory of the first face portion in the first expression animation generated for the first human face model and the correspondence between the first face portion and the first movement trajectory, the generated expression animation including the first movement trajectory is directly applied to the second face portion corresponding to the first face portion in the second human face model without being re-exploited for the second human face model to generate an expression animation same as the first human face model. In this way, an operation of generating the expression animation is simplified, thereby improving the generation efficiency of the expression animation and further overcoming the problem of high operation complexity of generating the expression animation in the related technologies.

In some exemplary embodiments, the apparatus further includes:

1) a second obtaining unit, configured to obtain a second expression adjustment instruction after the correspondence between the first face portion and the first movement trajectory is recorded, the second expression adjustment instruction being used for at least performing expression adjustment on the second face portion in the second human face model;

2) a third obtaining unit, configured to obtain the correspondence between the first face portion and the first movement trajectory; and

3) a second recording unit, configured to record the first movement trajectory indicated by the correspondence as a second movement trajectory of the second face portion in a second expression animation generated for the second human face model.

It should be noted that, in this exemplary embodiment, after the correspondence between the first face portion and the first movement trajectory is recorded, in the process of generating the second expression animation of the second face portion corresponding to the first face portion in the second human face model, the generated correspondence between the first face portion and the first movement trajectory may be, but is not limited to being recorded as the second movement trajectory of the second face portion in the second expression animation. That is, a movement trajectory corresponding to a new human face model is directly generated by using the generated movement trajectory without being re-exploited for the new human face model, so as to simplify an operation of regenerating the movement trajectory and improve the efficiency of generating the expression animation.

It should be noted that, in this exemplary embodiment, the first human face model and the second human face model may be, but are not limited to, the preset basic human face models in the terminal application. Therefore, in the process of generating the expression animation, the movement trajectory of the face portion in the expression animation generated in the first human face model may be directly applied to the second human face model.

Descriptions are specifically made with reference to the following examples. Assuming that the first face portion of the first human face model (for example, an ordinary woman) is the eye portion, and the first movement trajectory in the first expression animation is blinking, after the second expression adjustment instruction is obtained, assuming that the expression adjustment, indicated by the second expression adjustment instruction, performed on the second face portion (for example, which is also the eye portion) of the second human face model (for example, an ordinary man) is also blinking, in this way, a correspondence between the eye portion and the first movement trajectory of blinking when the ordinary woman blinks may be obtained. Further, the first movement trajectory indicated by the correspondence is recorded as the second movement trajectory of the eye portion of the ordinary man. That is, the movement trajectory of blinking of the ordinary woman is applied to the movement trajectory of blinking of the ordinary man, so as to achieve an object of simplifying the generation operation.

According to this exemplary embodiment provided by this application, after obtaining the second expression adjustment instruction used for at least performing expression adjustment on the second face portion in the second human face model, the correspondence between the first face portion and the first movement trajectory may be obtained. By recording the first movement trajectory indicated by the correspondence as the second movement trajectory, an object of simplifying the generation operation is achieved, avoiding individually exploiting a set of code for generating the expression animation for the second human face model. In addition, the consistency and vividness of the expression animations of different human face models are ensured.

In some exemplary embodiments,

the apparatus further includes: 1) a setting unit, configured to: respectively set expression control areas for the plurality of face portions included in the first human face model before the first expression adjustment instruction is obtained, each face portion in the plurality of face portions being corresponding to one or more expression control areas, and a control point in the expression control area at different positions in the expression control area being corresponding to different expressions of a face portion corresponding to the expression control area.

The first obtaining unit includes: 1) a detection module, configured to detect a control point moving operation, the control point moving operation being used for moving the control point, in a first expression control area corresponding to the first face portion in the expression control area, from a first position to a second position; a first obtaining module, configured to obtain the first expression adjustment instruction generated in response to the control point moving operation, the first position being corresponding to the first expression and the second position being corresponding to the second expression.

Descriptions are specifically made with reference to FIG. 5. After the first expression adjustment instruction is obtained, the expression control areas are set for the plurality of face portions included in the first human face model. Using the schematic diagram shown in FIG. 5 as an example, a plurality of expression control areas are set for the eye portion, for example, the left eyebrow start, the left eyebrow end, the right eyebrow start, the right eyebrow end, the left eye, and the right eye. A plurality of expression control areas are set for the lip portion, for example, a left lip corner, a lip center, and a right lip corner. A control point is respectively set in each expression control area, and the control point at different positions in the expression control area corresponds to different expressions. Referring to FIG. 5 and FIG. 6, when each control point is at the first position in the expression control area shown in FIG. 5, the first expression (for example, smile) is displayed, and when the position of the control point changes to the second position in the expression control area shown in FIG. 6, the second expression (for example, anger) is displayed.

It should be noted that, a progress bar of the “anger” expression may further be dragged herein to adjust an expression to the expression shown in FIG. 6 at a time. The position of the control point in each expression control area also correspondingly changes to the second position shown in FIG. 6.

Further, in this exemplary embodiment, when each control point in the corresponding expression control point is detected to move from the first position shown in FIG. 5 to the second position shown in FIG. 6, the first expression adjustment instruction generated in response to a moving operation of the control point may be obtained. For example, the first expression adjustment instruction is used for instructing to adjust from the first expression “smile” to the second expression “anger”.

In some exemplary embodiments, the number of the control points may be, but is not limited to, set to 26. Each control point has coordinate axial directions of three dimensions of X, Y, and Z. Each axial direction is provided with three types of parameters, for example, a displacement parameter, a rotation parameter, and a zooming in or out parameter. Each type of parameter has an independent value range. These parameters may control an adjustment range of facial expressions, so as to ensure richness of the expression animation. These parameters may be, but is not limited to being derived in a dat format and an effect is shown in FIG. 11.

According to this exemplary embodiment provided by this application, by respectively setting expression control areas for the plurality of face portions, the control point in the expression control area at different positions in the expression control area being corresponding to different expressions of a face portion corresponding to the expression control area, a corresponding expression adjustment instruction is obtained by detecting whether the position of the control point in the expression control area is moved. In this way, a facial expression change in the human face model is quickly and accurately obtained, further ensuring the generation efficiency of the expression animation in the human face model. In addition, by controlling different expressions by using the control points, an adjustment operation on an expression in the human face model is simplified and expression changes of the human face model are enabled to be richer and more vivid, so as to achieve an object of improving the user experience.

In some exemplary embodiments, the first recording unit 906 includes:

1) a recording module, configured to record the first expression control area corresponding to the first face portion and a correspondence, used for indicating the first movement trajectory, between the first position and the second position.

Descriptions are specifically made with reference to the following examples. It is assumed that the first face portion uses the lip potion shown in FIG. 5 and FIG. 6 as an example. In the process of adjusting from the first expression shown in FIG. 5 to the second expression shown in FIG. 6, recording a correspondence between the first movement trajectory in the generated first expression animation and the lip portion may be recording a correspondence between the first position shown in FIG. 5 (that is, the control point of the lip center shown in FIG. 5 is near the top and the control points in the left lip corner and the right lip corner are near the bottom) and the second position shown in FIG. 6 (that is, the control points in the left lip corner and the right lip corner shown in FIG. 6 move downward, and the control point of the lip center moves upward) of the control points in the first expression control area (that is, the left lip corner, the lip center, and the right lip corner) corresponding to the lip portion.

It should be noted that, in this exemplary embodiment, a specific process of the control points moving from the first position to the second position according to the first movement trajectory may be, but is not limited to being pre-stored in the backend. A corresponding first movement trajectory may be directly obtained when the correspondence between the first position and the second position is obtained. No limitation is set thereto in this exemplary embodiment.

According to this exemplary embodiment provided by this application, by recoding the correspondence between the first expression control area corresponding to the first face portion and the first position and the second position toward which the first movement trajectory used for indicating movement of the control point moves, it is convenient to generate a corresponding movement trajectory according to the position relationship, so as to generate a corresponding expression animation to overcome the problem of high operation complexity of generating the expression animation in the related technologies.

In some exemplary embodiments, the apparatus further includes:

1) a first detection unit, configured to detect a position of a cursor in the first human face model after the correspondence between the first face portion and the first movement trajectory is recorded, the human face model including the plurality of face portions;

2) a determining unit, configured to determine a to-be-operated face portion in the plurality of face portions according to the position;

3) a second detection unit, configured to detect a selecting operation on the to-be-operated face portion;

4) an editing unit, configured to edit the to-be-operated face portion in response to an obtained editing operation on the to-be-operated face portion to obtain an edited face portion; and

5) a displaying unit, configure to display the edited face portion in the first human face model.

In some exemplary embodiments, after the correspondence between the first face portion and the first movement trajectory is recorded, face adjustment may be performed on the to-be-operated face portions in the plurality of face portions the first human face model according to, but is not limited to, an adjustment instruction input by a user to obtain a human face model meeting the user requirements. That is, in this exemplary embodiment, the face portions of the first human face model may be adjusted to obtain a special human face model different from the basic human face model (for example, the first human face model and the second human face model). It should be noted that, in this exemplary embodiment, the foregoing process may alternatively be referred to as face sculpting. The special human face model meeting personal requirements and preference of the user is obtained by sculpting a face.

In some exemplary embodiments, adjusting the first human face model may be, but is not limited to, according to a position of a cursor detected in the first human face model, determining a to-be-operated face portion in the plurality of face portions of the human face model and editing the to-be-operated face portion, so as to directly edit the first human face model by using a face picking technology to obtain an edited face portion. Further, the edited face portion is displayed in the first human face model, that is, the special human face model obtained after face sculpting.

According to this exemplary embodiment provided by this application, by detecting the position of the cursor to determine the selected to-be-operated face portion in the plurality of face portions of the human face model, it is convenient to directly implement the editing process of the to-be-operated face portion without dragging a corresponding slider in an additional control list. The user is enabled to directly perform face picking editing on the human face model, so as to simplify the editing operation on the human face model.

In some exemplary embodiments, the to-be-operated face portion is the first face portion, the first face portion is an eye portion, the first movement trajectory in the first expression animation includes a first blinking movement trajectory of the eye portion, and the first blinking movement trajectory starts from a first static eye open angle of the eye portion.

The editing unit includes: 1) a first adjustment module, configure to adjust the first static eye open angle of the eye portion to a second static eye open angle.

The apparatus further includes: 2) a mapping module, configured to: map the first movement trajectory in the first expression animation to a second blinking movement trajectory according to the first static eye open angle and the second static eye open angle after the to-be-operated face portion is edited in response to the obtained editing operation on the to-be-operated face portion.

Descriptions are specifically made with reference to the following examples. It is assumed that the to-be-operated face portion is the first face portion, the first face portion is the eye portion, the first movement trajectory in the first expression animation includes the first blinking movement trajectory of the eye portion, and the first blinking movement trajectory starts from the first static eye open angle of the eye portion. The first static eye open angle is β as shown in FIG. 7.

For example, the obtained editing operation on the eye portion is adjusting the first static eye open angle β of the eye portion to the second static eye open angle θ, as shown in FIG. 7. Further, the first movement trajectory in the first expression animation is mapped to the second blinking movement trajectory according to the first static eye open angle β and the second static eye open angle θ. That is, the first blinking movement trajectory is adjusted based on the second static eye open angle θ to obtain, through mapping, the second blinking movement trajectory.

In some exemplary embodiments, the morpheme engine may be, but is not limited to being used to perform adjustment on the to-be-operated face portion (for example, the eye portion). In the entire expression animation generation process (for example, blinking) of the human face model, in this exemplary embodiment, a normal expression animation is blended with human face bones. That is, the face bone is multiplied by the normal animation, and a bone required by the face is maintained and then is blended with all normal bone animations. In this way, in the process of generating the expression animation, after the size of the eye portion in changed, the expression animation of the eye portion may still achieve an effect of closing, and further, the expression animation of the to-be-operated face portion (for example, the eye portion) is normally and naturally played.

For example, a flow of the expression animation generation is described with reference to FIG. 8: First, the static eye open angle (for example, a big eye pose or a small eye pose) is set, then a bone offset is obtained by blending the expression animation with a basic pose, and a local offset of eyes is further obtained. Subsequently, a mapping calculation is performed on the local offset of the eyes to obtain an offset of a new pose. Finally, the offset of the new pose is applied to the previously-set static eye open angle (for example, the big eye pose or the small eye pose) by modifying the bone offset, so as to obtain a final animation output.

A formula of the mapping calculation is as follows:

λ=P/(A+B)=0.5θ=β*(w+λ)β∈[0,30°]w∈[0,1]

According to this exemplary embodiment provided by this application, after the eye portion is adjusted from the first static eye open angle to the second static eye open angle, the first blinking movement trajectory corresponding to the first static eye open angle is mapped to the second blinking movement trajectory, so that it is ensured that the special human face model different from the basic human face model may accurately and vividly implement blinking, avoiding a problem that the eyes cannot close or excessively close.

In some exemplary embodiments, the mapping module includes:

θ=β*(w+λ) (3)

λ=P/(A+B) (4)

where θ is an angle between an upper eyelid and a lower eyelid in the eye portion in the second blinking movement trajectory, β is an angle between the upper eyelid and the lower eyelid in the eye portion in the first blinking movement trajectory, w is a preset value, w∈[0,1], P is the first static eye open angle, A is a maximum angle to which the first static eye open angle is allowed to be adjusted, and B is a minimum angle to which the first static eye open angle is allowed to be adjusted; and

w+λ=the second static eye open angle/the first static eye open angle.

According to this exemplary embodiment of this application, the second blinking movement trajectory obtained by mapping the first blinking movement trajectory may be calculated by the foregoing formula, so that the accuracy and vividness of the expression animation may be ensured at the same time when expression animation generation of the human face model is simplified.

In some exemplary embodiments, the determining unit includes:

1) a second obtaining module, configured to obtain a color value of a pixel at the position; and

2) a determining module, configured to determine the to-be-operated face portion corresponding to the color value in the plurality of face portions.

In some exemplary embodiments, the obtaining a color value of a pixel at the position may include, but is not limited to: obtaining a color value that is of a pixel corresponding to the position and that is in a mask map. The mask map is in contact with the human face model and includes a plurality of mask areas in one-to-one correspondence with the plurality of face portions. Each mask area corresponds to one face portion. The color of the pixel may include one of the following: a red color value of the pixel, a green color value of the pixel, and a blue color value of the pixel.

It should be noted that, in this exemplary embodiment, each mask area on the mask map in contact with the human face model is respectively in one-to-one correspondence with one face portion on the human face model. That is, by selecting, by the cursor, the mask area on the mask map in contact with the human face model, the face portion corresponding to the human face model is selected, so that the face portion on the human face model is directly edited, achieving an object of simplifying the editing operation.

For example, refer to Table 1, when the obtained R color value of the pixel of the position of the cursor is 200, a corresponding mask area may be determined by searching a preset mapping relationship, thereby obtaining a to-be-operated face portion corresponding to the mask area, that is, a “nasal bridge”.

According to this exemplary embodiment provided by this application, by the obtained color value of the pixel of the position of the cursor, the to-be-operated face portion corresponding to the color value in the plurality of face portions is determined. That is, the to-be-operated face portion is determined by using the color value of the pixel of the position of the cursor, so that the editing operation may be directly performed on the face portion in the human face model to achieve an object of simplifying the editing operation.

In some exemplary embodiments, the second obtaining module includes:

1) a obtaining submodule, configured to obtain the color value that is of a pixel corresponding to the position and that is in a mask map, the mask map being in contact with the human face model and including a plurality of mask areas in one-to-one correspondence with the plurality of face portions, and each mask area being corresponding to one face portion.

The color value of the pixel includes one of the following: the red color value of the pixel, the green color value of the pixel, and the blue color value of the pixel.

Descriptions are specifically made with reference to the following examples. According to the anthropotomy, 48 bones may affect a classification of muscles, so as to obtain a muscle portion control list and set an R color value for each portion. To avoid an error, a minimum of 10 units exists between each value. Further, according to a distribution status of these portions on the human face, a mask map corresponding to the human face model may be obtained by using the R color values corresponding to these portions. Table 1 shows the R color values of the nose portion in the human face model.

That is, the mask map corresponding to the human face model may be drawn according to the R color value in the mapping relationship. The mask map is in contact with the human face model and the plurality of mask areas included by the mask map is in one-to-one correspondence with the plurality of face portions.

According to this exemplary embodiment provided by this application, the corresponding color value of the pixel is obtained by referring to the mask map in contact with the human face model, so that the color value of the pixel of the position of the cursor is accurately obtained and a corresponding to-be-operated face portion is obtained according to the color value.

In some exemplary embodiments, the apparatus further includes:

1) a second displaying unit, configured to: display the human face model and the generated mask map before the position in the displayed human face model of the cursor is detected, the mask map being set as to be in contact with the human face model.

According to this exemplary embodiment provided by this application, before the position in the displayed human face model of the cursor is detected, an image combined by the human face model and the generated mask map is displayed in advance, so that when the position of the cursor is detected, a corresponding position may be directly and quickly obtained by using the mask map. Further, the to-be-operated face portion in the plurality of face portions of the human face model is accurately obtained and an object of improving the editing efficiency is achieved.

In some exemplary embodiments, the apparatus further includes:

1) a third displaying unit, configured to highlight the to-be-operated face portion in the human face model when the selecting operation on the to-be-operated face portion is detected.

In some exemplary embodiments, when the selecting operation on the to-be-operated face portion is detected, the solution may include, but is not limited to, specially displaying on the to-be-operated face portion. For example, the face portion is highlighted, shadow is displayed at the face portion, or the like. No limitation is set thereto in this exemplary embodiment.

According to this exemplary embodiment provided by this application, by highlighting the to-be-operated face portion, the user is enabled to intuitively see the editing operation performed on the face portion in the human face model, so as to implement what a person sees is what the person gets. In this way, the editing operation may be closer to the user requirements and the user experience is improved.

In some exemplary embodiments, the editing unit includes at least one of the following:

1) a first editing module, configured to move the to-be-operated face portion;

2) a second editing module, configured to rotate the to-be-operated face portion;

3) a third editing module, configured to zoom in the to-be-operated face portion; and

4) a fourth editing module, configured to zoom out the to-be-operated face portion.

In some exemplary embodiments, a manner of implementing the foregoing editing operation may be, but is not limited to at least one of the following: clicking and dragging. That is, by using a combination of different operation manners, at least one of the following editing is performed on the to-be-operated face portion: moving, rotating, zooming in, and zooming out.

According to this exemplary embodiment provided by this application, different types of editing is performed on the to-be-operated face portion on the human face model, so that the editing operation is simplified, the editing efficiency is improved, and the problem of high operation complexity in the related technologies is overcome.

### Exemplary Embodiment 3

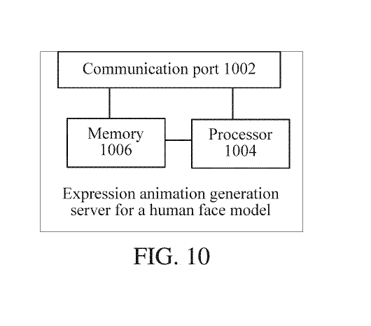

According to the exemplary embodiments, an expression animation generation server for a human face model used for implementing the foregoing expression animation generation method for a human face model is provided, as shown in FIG. 10, the server includes:

1) a communication port 1002, configured to obtain a first expression adjustment instruction, the first expression adjustment instruction being used for performing expression adjustment on a first face portion in a plurality of face portions included in a first human face model;

2) a processor 1004, connected to the communication port 1002, configured to adjust the first face portion from a first expression to a second expression in response to the first expression adjustment instruction, and further configured to: in the process of adjusting the first face portion from the first expression to the second expression, record a movement trajectory of the first face portion as a first movement trajectory of the first face portion in a first expression animation generated for the first human face model, and record a correspondence between the first face portion and the first movement trajectory, the correspondence being used for adjusting a second face portion, corresponding to the first face portion in a second human face model, from the first expression to the second expression; and

3) a memory 1006, connected to the communication port 1002 and the processor 1004, and configured to store the first movement trajectory of the first face portion in the first expression animation generated for the first human face model and the correspondence between the first face portion and the first movement trajectory.

Optionally, for a specific example in this exemplary embodiment, refer to the examples described in Exemplary embodiment 1 and Exemplary embodiment 2, and details are not described herein again in this exemplary embodiment.

### Exemplary Embodiment 4

The exemplary embodiments further provide a storage medium. In some exemplary embodiments, the storage medium is configured to store program code used for executing the following steps:

S1: Obtain a first expression adjustment instruction, the first expression adjustment instruction being used for performing expression adjustment on a first face portion in a plurality of face portions included in a first human face model.

S2: Adjust the first face portion from a first expression to a second expression in response to the first expression adjustment instruction.

S3: In the process of adjusting the first face portion from the first expression to the second expression, record a movement trajectory of the first face portion as a first movement trajectory of the first face portion in a first expression animation generated for the first human face model, and record a correspondence between the first face portion and the first movement trajectory, the correspondence being used for adjusting a second face portion, corresponding to the first face portion in a second human face model, from the first expression to the second expression.

In some exemplary embodiments, the storage medium is further configured to store program code used for executing the following steps: obtaining a second expression adjustment instruction after the correspondence between the first face portion and the first movement trajectory is recorded, the second expression adjustment instruction being used for at least performing expression adjustment on the second face portion in the second human face model; obtaining the correspondence between the first face portion and the first movement trajectory; and recording the first movement trajectory indicated by the correspondence as a second movement trajectory of the second face portion in a second expression animation generated for the second human face model.

In some exemplary embodiments, the storage medium is further configured to store program code used for executing the following steps: before the obtaining a first expression adjustment instruction, the steps further include: respectively setting expression control areas for the plurality of face portions included in the first human face model, each face portion in the plurality of face portions being corresponding to one or more expression control areas, and a control point in the expression control area at different positions in the expression control area being corresponding to different expressions of a face portion corresponding to the expression control area; and the obtaining a first expression adjustment instruction includes: detecting a control point moving operation, the control point moving operation being used for moving the control point, in a first expression control area corresponding to the first face portion in the expression control area, from a first position to a second position; and obtaining the first expression adjustment instruction generated in response to the control point moving operation, the first position being corresponding to the first expression and the second position being corresponding the second expression.

In some exemplary embodiments, the storage medium is further configured to store program code used for executing the following steps: recording the first expression control area corresponding to the first face portion and a correspondence, used for indicating the first movement trajectory, between the first position and the second position.

In some exemplary embodiments, the storage medium is further configured to store program code used for executing the following steps: where the first expression animation includes at least one movement trajectory of at least one face portion in the plurality of face portions, at least one movement trajectory of at least one face portion including the first movement trajectory of the first face portion; the at least one movement trajectory in the first expression animation is the same as a movement trajectory corresponding to the at least one movement trajectory in the second expression animation; and a first display manner of the at least one movement trajectory when the first expression animation is displayed is the same as a second display manner of the movement trajectory corresponding to the at least one movement trajectory in the second expression animation when the second expression animation is displayed.

In some exemplary embodiments, the storage medium is further configured to store program code used for executing the following steps: detecting a position of a cursor in the first human face model after the correspondence between the first face portion and the first movement trajectory is recorded, the human face model including the plurality of face portions; determining a to-be-operated face portion in the plurality of face portions according to the position; detecting a selecting operation on the to-be-operated face portion; editing the to-be-operated face portion in response to an obtained editing operation on the be-operated face portion to obtain an edited face portion; and displaying the edited face portion in the first human face model.

In some exemplary embodiments, the storage medium is further configured to store program code used for executing the following steps: where the to-be-operated face portion is the first face portion, the first face portion is an eye portion, the first movement trajectory in the first expression animation includes a first blinking movement trajectory of the eye portion, and the first blinking movement trajectory starts from a first static eye open angle of the eye portion; the editing the to-be-operated face portion in response to an obtained editing operation on the to-be-operated face portion includes adjusting the first static eye open angle of the eye portion to a second static eye open angle; and after the editing the to-be-operated face portion in response to an obtained editing operation on the to-be-operated face portion, the step further includes mapping the first movement trajectory in the first expression animation to a second blinking movement trajectory according to the first static eye open angle and the second static eye open angle.

In some exemplary embodiments, the storage medium is further configured to store program code used for executing the following steps: the mapping the first movement trajectory in the first expression animation to a second blinking movement trajectory according to the first static eye open angle and the second static eye open angle includes:

θ=β*(w+λ)

λ=P/(A+B)

where θ is an angle between an upper eyelid and a lower eyelid in the eye portion in the second blinking movement trajectory, β is an angle between the upper eyelid and the lower eyelid in the eye portion in the first blinking movement trajectory, w is a preset value, w∈[0,1], P is the first static eye open angle, A is a maximum angle to which the first static eye open angle is allowed to be adjusted, and B is a minimum angle to which the first static eye open angle is allowed to be adjusted; and

w+λ=the second static eye open angle/the first static eye open angle.

In some exemplary embodiments, the storage medium is further configured to store program code used for executing the following steps: obtaining a color value of a pixel at the position; and determining the to-be-operated face portion corresponding to the color value in the plurality of face portions.

In some exemplary embodiments, the storage medium is further configured to store program code used for executing the following steps: where the editing the to-be-operated face portion in response to an obtained editing operation on the be-operated face portion includes at least one of the following: moving the to-be-operated face portion; rotating the to-be-operated face portion; zooming in the to-be-operated face portion; and zooming out the to-be-operated face portion.

In some exemplary embodiments, the foregoing storage medium may include, but is not limited to: any medium that may store program code, such as a USB flash drive, a read-only memory (ROM), a random access memory (RAM), a removable hard disk, a magnetic disk, or an optical disc.

Optionally, for a specific example in this exemplary embodiment, refer to the examples described in Exemplary embodiment 1 and Exemplary embodiment 2, and details are not described herein again in this exemplary embodiment.

The sequence numbers of the preceding exemplary embodiments are merely for description purpose but do not indicate the preference of the exemplary embodiments.

When the integrated unit in the foregoing exemplary embodiment is implemented in a form of a software functional module and sold or used as an independent product, the integrated unit may be stored in the foregoing computer-readable storage medium. Based on such an understanding, the technical solutions of the present disclosure essentially, or the part contributing to the related technologies, or all or some of the technical solutions may be implemented in a form of a software product. The computer software product is stored in a storage medium and includes several instructions for instructing one or more computer devices (which may be a personal computer, a server, or a network device) to perform all or some of the steps of the methods in the exemplary embodiments.

In the foregoing exemplary embodiments, the description of each exemplary embodiment has respective focuses, and for the part that is not detailed in an exemplary embodiment, the relevant description of other exemplary embodiments may be referred to.

In the several exemplary embodiments provided in this application, it should be understood that the disclosed client may be implemented in other manners. For example, the described apparatus exemplary embodiment is merely exemplary. For example, the unit division is merely logical function division and may be other division in actual implementation. For example, multiple units or components may be combined or integrated into another system, or some features may be ignored or not performed. In addition, the displayed or discussed mutual couplings or direct couplings or communication connections may be implemented by using some interfaces. The indirect couplings or communication connections between the units or modules may be implemented in electronic, mechanical, or other forms.

The units described as separate parts may or may not be physically separate, and parts displayed as units may or may not be physical units, may be located in one position, or may be distributed on a plurality of network units. Some or all of the units may be selected to achieve the objectives of the solutions of the exemplary embodiments.

In addition, functional units in the exemplary embodiments may be integrated into one processing unit, or each of the units may exist alone physically, or two or more units are integrated into one unit. The integrated unit may be implemented in a form of hardware, or may be implemented in a form of a software functional unit.

The foregoing descriptions are merely exemplary implementations of the present disclosure. It should be noted that a person of ordinary skill in the art may make several improvements or polishing without departing from the principle of the present disclosure and the improvements or polishing shall fall within the protection scope of the present disclosure.

In the exemplary embodiments, by adjusting the expression of the first face portion in the first human face model in response to the first expression adjustment instruction, and recording, in the adjustment process, the first movement trajectory of the first face portion in the first expression animation generated for the first human face model and the correspondence between the first face portion and the first movement trajectory, the generated expression animation including the first movement trajectory is directly applied to the second face portion corresponding to the first face portion in the second human face model without being re-exploited for the second human face model to generate an expression animation same as the first human face model. In this way, an operation of generating the expression animation is simplified, thereby improving the generation efficiency of the expression animation and further and overcoming the problem of high operation complexity of generating the expression animation in the related technologies.

What is claimed is:

1. A method comprising:
adjusting a first face portion from a first expression to a second expression in a first face model based on an adjustment instruction;
recording a movement trajectory of the first face portion from the first expression to the second expression in the first face model, and a correspondence between the first face portion and the movement trajectory; and
adjusting, on a second face model which is different than the first face model, a second face portion that corresponds to the first face portion, based on the movement trajectory and the correspondence between the first face portion and the movement trajectory.

2. The method of claim 1, wherein the adjusting the second face portion comprises directly applying the movement trajectory to the second face portion based on the correspondence between the first face portion and the movement trajectory.

3. The method of claim 1, wherein the adjusting the first face portion comprises animating the first face portion to change from the first expression to the second face expression in the first face model, and the adjusting the second face portion comprises animating the second face portion to change according to the movement trajectory.

4. The method of claim 1, wherein the movement trajectory comprises a plurality of movement trajectories for the first face portion, and
the second face portion is adjusted based on the plurality of movement trajectories.

5. The method of claim 4, wherein the plurality of movement trajectories are a same movement trajectory repeated a plurality of times.

6. The method of claim 4, wherein the plurality of movement trajectories are each different movement trajectories.

7. The method of claim 1, wherein the first face model comprises a plurality of first face portions, and the first face model is adjusted from the first expression to the second expression by adjusting at least a portion of the plurality of first face portions,
wherein a movement trajectory is recorded for each of the portion of the plurality of first face portions, and a correspondence between each of the portion of the plurality of first face portions and its corresponding movement trajectory is recorded, and
wherein the second face model comprises a plurality of second face portions corresponding respectively to the plurality of first face portions, and a portion of the plurality of second face portions that correspond to the portion of the plurality of first face portions are adjusted based on the respective movement trajectories and the respective correspondences.

8. The method of claim 1, wherein second face portion is adjusted from a third expression to a fourth expression on the second face model, based on the movement trajectory and the correspondence between the first face portion and the movement trajectory, and
the method further comprises:
recording another movement trajectory of the second face portion from the third expression to the fourth expression in the second face model, and a correspondence between the second face portion and the another movement trajectory; and
adjusting, on a third face model which is different than the first and second face models, a third face portion that corresponds to the second face portion, based on the another movement trajectory and the correspondence between the second face portion and the another movement trajectory.

9. The method of claim 1, wherein:
one or more expression control areas are set for each of the first face portion and the second face portion,
a control point is respectively set within each of the one or more expression control areas based on an expression being adjusted; and
a position of the control points are adjusted according to the movement trajectory and expressions being adjusted.

10. An apparatus comprising:
at least one memory configured to store computer program code; and
at least one processor configured to access the at least one memory and operate according to the computer program code, the computer program code including:
first adjusting code configured to cause at least one of the at least one processor to adjust a first face portion from a first expression to a second expression in a first face model based on an adjustment instruction;
recording code configured to cause at least one of the at least one processor to record a movement trajectory of the first face portion from the first expression to the second expression in the first face model, and a correspondence between the first face portion and the movement trajectory; and
second adjusting code configured to cause at least one of the at least one processor to adjust, on a second face model which is different than the first face model, a second face portion that corresponds to the first face portion, based on the movement trajectory and the correspondence between the first face portion and the movement trajectory.

11. The apparatus of claim 10, wherein the second adjusting code is configured to cause the at least one of the at least one processor to directly apply the movement trajectory to the second face portion based on the correspondence between the first face portion and the movement trajectory.

12. The apparatus of claim 10, wherein the first adjusting code is configured to cause the at least one of the at least one processor to animate the first face portion to change from the first expression to the second face expression in the first face model, and the second adjusting code is configured to cause the at least one of the at least one processor to animate the second face portion to change according to the movement trajectory.

13. The apparatus of claim 10, wherein the movement trajectory comprises a plurality of movement trajectories for the first face portion, and
the second face portion is adjusted based on the plurality of movement trajectories.

14. The apparatus of claim 13, wherein the plurality of movement trajectories are a same movement trajectory repeated a plurality of times.

15. The apparatus of claim 13, wherein the plurality of movement trajectories are each different movement trajectories.

16. The apparatus of claim 10, wherein the first face model comprises a plurality of first face portions, and the first face model is adjusted from the first expression to the second expression by adjusting at least a portion of the plurality of first face portions,
wherein a movement trajectory is recorded for each of the portion of the plurality of first face portions, and a correspondence between each of the portion of the plurality of first face portions and its corresponding movement trajectory is recorded, and
wherein the second face model comprises a plurality of second face portions corresponding respectively to the plurality of first face portions, and a portion of the plurality of second face portions that correspond to the portion of the plurality of first face portions are adjusted based on the respective movement trajectories and the respective correspondences.

17. The apparatus of claim 10, wherein second face portion is adjusted from a third expression to a fourth expression on the second face model, based on the movement trajectory and the correspondence between the first face portion and the movement trajectory, and
the computer program code further comprises:
second recording code configured to cause at least one of the at least one processor to record another movement trajectory of the second face portion from the third expression to the fourth expression in the second face model, and a correspondence between the second face portion and the another movement trajectory; and
second adjusting code configured to cause at least one of the at least one processor to adjust, on a third face model which is different than the first and second face models, a third face portion that corresponds to the second face portion, based on the another movement trajectory and the correspondence between the second face portion and the another movement trajectory.

18. The apparatus of claim 10, wherein:
one or more expression control areas are set for each of the first face portion and the second face portion,
a control point is respectively set within each of the one or more expression control areas based on an expression being adjusted; and
a position of the control points are adjusted according to the movement trajectory and expressions being adjusted.

19. A non-transitory computer readable storage medium comprising computer readable code which, when executed by at least one processor, causes the at least one processor to perform:
animating a first face portion to change from a first expression to a second expression in a first face model based on an adjustment instruction;
recording a movement trajectory of the first face portion from the first expression to the second expression in the first face model, and a correspondence between the first face portion and the movement trajectory; and
animating, on a second face model which is different than the first face model, a second face portion that corresponds to the first face portion, based on the movement trajectory and the correspondence between the first face portion and the movement trajectory.

20. The computer readable storage medium of claim 19, wherein the second face portion is directly animated according to the movement trajectory without determining a to and from expression of the second face model.
